(19) United States
(12) Patent Application Publication
(10) Pub. No.: US 2026/0170883 A1
(43) Pub. Date: Jun. 18, 2026

(54) APPARATUS FOR CONTROLLING A VEHICLE AND A METHOD THEREOF

(71) Applicants: HYUNDAI MOTOR COMPANY, Seoul (KR); KIA CORPORATION, Seoul (KR)

(72) Inventor: Dae Hyun Kim, Hwaseong-si (KR)

(73) Assignees: HYUNDAI MOTOR COMPANY, Seoul (KR); KIA CORPORATION, Seoul (KR)

(21) Appl. No.: 19/228,118

(22) Filed: Jun. 4, 2025

(30) Foreign Application Priority Data
Dec. 13, 2024 (KR) 10-2024-0186425

(51) Int. Cl. G07C 5/00; H04L 9/40; H04L 12/40; H04W 4/40

(52) U.S. Cl. CPC G07C 5/008; H04L 12/40; H04L 63/1425; H04W 4/40; H04L 2012/40215

(57) ABSTRACT

A vehicle control apparatus may include a storage including a first message queue and a second message queue for storing messages in a vehicle. The vehicle control apparatus may also include a processor configured to detect an abnormal message, determine a number of occurrences of the abnormal message, and compare the number of occurrences of the abnormal message with an error counter threshold. The processor may be configured to store the abnormal message in the first message queue or the second message queue based on the comparison. The processor may also be configured to store the abnormal message as log data in a memory based on determining whether the abnormal message is a signal affecting safety in the vehicle. The processor may also be configured to transmit the log data stored in the memory to a server.

### CROSS-REFERENCE TO RELATED APPLICATION

This application claims the benefit of and priority to Korean Patent Application No. 10-2024-0186425, filed in the Korean Intellectual Property Office on Dec. 13, 2024, the entire contents of which are hereby incorporated herein by reference.

### TECHNICAL FIELD

The present disclosure relates to a vehicle control apparatus and a method thereof, and more specifically, relates to a technology for protecting a vehicle internal network and a system.

### BACKGROUND

Intelligent Transportation System (ITS) refers to an integrated transportation system that optimizes the interaction between transportation infrastructure, vehicles, roads, and users by using advanced information and communication technology (ICT) to improve safety, efficiency, and convenience. Nowadays, with the development of wireless communication systems, for example, services for smart cities and smart cars are embodied based on 3G, 4G, and 5G communication technologies and IoT-related technologies. Moreover, Ultra-high-speed communication, low latency, and mass data transmission are supported by using 5G-Adv, 6G and next-generation communication technologies and IoT security, edge computing/network slicing, low power wide area (LPWA), and the like, and communication between vehicles and external entities such as other vehicles and infrastructure is also becoming widespread.

A vehicle typically includes a communication control unit (CCU) to exchange or share communication information with the outside. While communicating with another vehicle in real time through the CCU and exchanging driving information with each other, the vehicles may predict collision accidents and road conditions more efficiently. For example, vehicle-to-everything (V2X) refers to a communication method of exchanging or sharing information such as traffic conditions while a vehicle communicates with road infrastructure and other vehicles while driving, and is developing into a technology that allows all elements (vehicle-to-vehicle, vehicle-to-infrastructure, vehicle-to-pedestrian, vehicle-to-network, and the like) of a road to exchange information in real time. Accordingly, the number of electronic control units (ECU) installed in vehicles continues to increase significantly. In addition, as vehicles are connected to external networks through wired and wireless networks, an effective intrusion detection system (IDS) for detecting and responding to security threats to the internal network of the vehicle is becoming increasingly important.

### SUMMARY

The present disclosure was made to solve the above-mentioned problems occurring in the prior art while advantages achieved by the prior art are maintained intact.

Aspects of the present disclosure provide a vehicle control apparatus and method for protecting a vehicle internal network and a system.

Aspects of the present disclosure provide a vehicle control apparatus and method for controlling log storage based on characteristics of abnormal messages.

Aspects of the present disclosure provide a vehicle control apparatus and method for detecting abnormal messages and storing log data.

Aspects of the present disclosure provide a vehicle control apparatus and method for providing network security for identifying and managing abnormal messages.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, a vehicle control apparatus is provided. The vehicle control apparatus includes a storage including a first message queue and a second message queue for storing messages in a vehicle. The vehicle control apparatus also includes a processor configured to detect an abnormal message, determine a number of occurrences of the abnormal message, and compare the number of occurrences of the abnormal message with an error counter threshold. The processor is configured to store the abnormal message in the first message queue or the second message queue based on the comparison.

The processor is also configured to store the abnormal message stored in the second message queue as log data stored in a memory based on determining whether the abnormal message is a signal affecting safety in the vehicle. The processor is further configured to transmit the log data stored in the memory to a server.

In an embodiment, the processor may be configured to variably set the error counter threshold based on an electronic control apparatus (ECU) associated with the abnormal message.

In an embodiment, the processor may be configured to compare the number of occurrences of the abnormal message with the error counter threshold by applying an abnormal detection ruleset.

In an embodiment, the processor may be configured to apply the abnormal detection ruleset that variably sets the error counter threshold based on at least one of a role and stability of the ECU, signal vulnerability, or importance of log management.

In an embodiment, the processor may be configured to store the abnormal message in the second message queue based on determining that the number of occurrences of the abnormal message reaches the error counter threshold. The second message queue may be a confirmed abnormal message queue.

In an embodiment, the processor may be configured to store the abnormal message stored in the second message queue as the log data in the memory based on determining that the abnormal message stored in the second message queue is a signal that affects safety of the vehicle.

In an embodiment, the memory may comprise an electrically erasable programmable read-only memory (EEPROM).

In an embodiment, the processor may be configured to store the abnormal message in the first message queue based on determining that the number of occurrences of the abnormal message does not reach the predetermined error counter threshold. The first message queue may be an abnormal message queue.

In an embodiment, the processor may be configured to store the abnormal message stored in the first message queue as the log data in the memory based on determining that an engine of the vehicle is in a deactivated state (IGN Off).

In an embodiment, the processor may be configured to transmit the abnormal message stored in the memory to the server as the log data to allow an abnormal detection ruleset for an intrusion detection system, which detects the abnormal message, to be updated based on the log data.

According to another aspect of the present disclosure, a vehicle control method is provided. The vehicle control method includes detecting an abnormal message, determining a number of occurrences of the abnormal message, and comparing the number of occurrences of the abnormal message with an error counter threshold. The vehicle control method also includes storing the abnormal message in a first message queue or a second message queue based on the comparison. The vehicle control method additionally includes storing the abnormal message as log data in a memory based on determining whether the abnormal message is a signal affecting safety in a vehicle. The vehicle control method further includes transmitting the log data stored in the memory to a server.

In an embodiment, the vehicle control method may include variably setting the error counter threshold based on an ECU associated with the abnormal message.

In an embodiment, comparing the number of occurrences of the abnormal message with the error counter threshold may include comparing the number of occurrences of the abnormal message with the error counter threshold by applying an abnormal detection ruleset.

In an embodiment, applying the abnormal detection ruleset may include variably setting the error counter threshold based on at least one of a role and stability of the ECU, a signal vulnerability, or importance of log management.

In an embodiment, storing the abnormal message in the second message queue may include storing the abnormal message in the second message queue based on determining that the number of occurrences of the abnormal message reaches the predetermined error counter threshold. The second message queue may be a confirmed abnormal message queue.

In an embodiment, storing the abnormal message stored in the second message queue to be stored as the log data in the memory may include storing the abnormal message stored in the second message queue as the log data in the memory based on determining that the abnormal message stored in the second message queue is a signal that affects safety of the vehicle.

In an embodiment, the memory may comprise an electrically erasable programmable read-only memory (EEPROM).

In an embodiment, the storing the abnormal message in the first message queue may include storing the abnormal message in the first queue based on determining that the number of occurrences of the abnormal message does not reach the predetermined error counter threshold. The first message queue may be an abnormal message queue.

In an embodiment, the method may further include storing the abnormal message stored in the first message queue as the log data in the memory based on determining that an engine of the vehicle being in a deactivated state (IGN Off).

In an embodiment, the method may further include updating an abnormal detection ruleset for an intrusion detection system that detects the abnormal message. The abnormal detection ruleset may be updated based on the log data transmitted to the server.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a block diagram illustrating a configuration of a vehicle system including a vehicle control apparatus, according to an embodiment of the present disclosure;

FIG. 2 is a schematic diagram of a vehicle communication control system that efficiently controls wireless network connections to reduce power consumption, according to an embodiment of the present disclosure;

FIG. 3 is a block diagram showing a configuration of a vehicle control apparatus including an intrusion detection system (IDS), according to an embodiment of the present disclosure;

FIGS. 4A and 4B are conceptual diagrams for describing a method for identifying and processing abnormal messages in a vehicle control apparatus, according to an embodiment of the present disclosure;

FIG. 5 is a conceptual diagram for describing a method for identifying and processing abnormal messages in a vehicle control apparatus, according to another embodiment of the present disclosure;

FIGS. 6 and 7 are conceptual diagrams for describing a process for identifying and processing abnormal messages in a vehicle control apparatus, according to an embodiment of the present disclosure;

FIG. 8 is a signal flow diagram for describing a process of identifying and processing abnormal messages, according to an embodiment of the present disclosure;

FIG. 9 is a signal flow diagram for describing a process of identifying and processing an abnormal message, according to an embodiment of the present disclosure; and

FIG. 10 illustrates a computing system according to an embodiment of the present disclosure.

### DETAILED DESCRIPTION

Hereinafter, embodiments of the present disclosure are described in detail with reference to the accompanying drawings. In adding reference numerals to components of each drawing, it should be noted that the same components are designated by the same reference numerals even when the components are illustrated on different drawings. Furthermore, in describing the embodiments of the present disclosure, where it was determined that a detailed description of well-known functions or configurations would unnecessarily obscure the gist of the present disclosure, the detailed description thereof has been omitted.

In describing elements of an embodiment of the present disclosure, the terms first, second, A, B, (a), (b), and the like may be used herein. These terms are only used to distinguish one element from another element. These terms do not limit the corresponding elements irrespective of the nature, order, or priority of the corresponding elements. Furthermore, unless otherwise defined, all terms used herein, including technical or scientific terms, include the same meaning as commonly understood by one of ordinary skill in the art to which the present disclosure pertains. It should be understood that terms used herein should be interpreted as including a meaning that is consistent with their meaning in the context of the present disclosure and the relevant art. The terms should not be interpreted in an idealized or overly formal sense unless expressly so defined herein.

In the present disclosure, when a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, module, apparatus, gateway, server, and the like may separately embody or be included with a processor and a memory, such as a non-transitory computer readable media, as part of the apparatus.

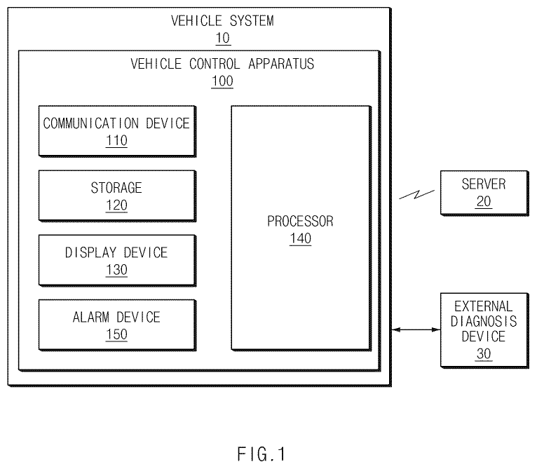

Hereinafter, embodiments of the present disclosure are described in detail with reference to FIGS. 1-10.

FIG. 1 is a block diagram illustrating a configuration of a vehicle system 10 including a vehicle control apparatus, according to an embodiment of the present disclosure.

Referring to FIG. 1, a vehicle control apparatus 100 according to an embodiment of the present disclosure may be provided in a vehicle. For example, the vehicle control apparatus 100 may be integrated with internal control units of the vehicle and/or may be implemented with a separate device so as to be coupled with control units of the vehicle by means of a separate connection means. As an example, the vehicle control apparatus 100 may include a transmission control apparatus that comprehensively manages and controls various subsystems (a transmission, an engine, a brake, etc.) of a vehicle. Additionally, the vehicle control apparatus 100 may include an intrusion detection control apparatus that integrates an intrusion detection system (IDS) to protect a vehicle's internal network and a system. The vehicle control apparatus 100 according to an embodiment of the present disclosure may include a transmission control apparatus and an intrusion detection system to manage physical and digital elements in an integrated manner, and may be formed integrally with control units that ensure the safety and performance of the vehicle, or may be implemented as a separate device so as to be connected to the control units of the vehicle.

According to an embodiment of the present disclosure, the vehicle control apparatus 100 may include a communication device 110, storage 120, a display device 130, a processor 140, and an alarm device 150.

The communication device 110 may be a hardware device implemented with various electronic circuits for transmitting and receiving signals over a wireless or wired connection. According to an embodiment of the present disclosure, the communication device 110 may perform communication in the vehicle through Controller Area Network (CAN) communication, CAN-FD communication, LIN communication, Ethernet communication, and/or the like. The communication device 110 may include various communication units such as a mobile communication unit for communication with a server 20 and an external diagnosis device 30, which may be placed outside a vehicle, a broadcast receiving unit such as a DMB module or a DVB-H module, a short range communication unit such as a Zigbee module being a Bluetooth module or an NEC module, a Wi-Fi communication unit, and/or the like. The CAN communication is a vehicle network system developed to provide digital serial communication between various measurement and control devices in a vehicle. In an embodiment, the CAN-data bus is used to transmit and control data between electronic control units (ECUs) in the vehicle. Furthermore, the communication device 110 according to an embodiment of the present disclosure may perform bidirectional communication with surrounding or adjacent vehicles, between a vehicle and a surrounding or adjacent vehicle, between a vehicle and a road infrastructure, and between a vehicle and a pedestrian, etc. The communication device 110 may continuously share and send/receive data with all elements including the host vehicle and surrounding or adjacent vehicles. The communication device 110 may be implemented to be mounted on the vehicle itself or to be in contact with a communication terminal. In this way, it is possible to perform communication between vehicles and infrastructure communication between vehicles, and it is possible to autonomously drive to the specified destination through one or more vehicle sensors and a driving control function provided in the vehicle. The one or more vehicle sensors may include at least one of a global positioning system (GPS) sensor, a gyro sensor, or an acceleration sensor. The GPS sensor, the gyroscope sensor, and/or the acceleration sensor may measure a vehicle's location, movement, and attitude, and may be coupled with other sensors in the vehicle to support driving safety, autonomous driving, navigation system, and/or vehicle tracking and management. For example, the gyro sensor and the acceleration sensor may be coupled with LiDAR, cameras, and PADAR to monitor the vehicle's position and attitude in real time, and the vehicle's rotation and acceleration may be controlled while the gyro sensor and the acceleration sensor are coupled with each other. Further, precise path tracking and real-time driving control for autonomous vehicles may be performed by tracking a location through the GPS sensor, maintaining a direction by using the gyroscope sensor, and detecting movement changes by using the acceleration sensor. Moreover, environmental sensors that recognize external environments may include LiDAR generating 3D terrain data around a vehicle by using lasers, PADAR measuring the distance and speed of the vehicle by using radio waves, ultrasonic sensors detecting objects at a short distance (e.g., parking assistance systems), and camera sensors maintaining lanes, recognizing road signs, and detecting pedestrians. In various embodiments, various sensor fusion technologies may be applied.

The communication device 110 may support WAVE communication technology for V2X communication function and/or may support communication technology including 3GPP-based LTE, NR, 5G-Adv, and/or 6G systems. For example, when a new radio (NR) access technology of 5G system is supported, the NR access technology may support enhanced mobile broadband (eMBB), massive machine type communications (mMTC), or ultra-reliable and low-latency communications (URLLC). The wireless communication module may support a high frequency band (e.g., mmWave band) to achieve a high data transfer rate. The wireless communication module may support various technologies to be applied to secure performance in a high frequency band, for example, beamforming, massive multiple-input and multiple-output (massive MIMO), full dimensional MIMO (FD-MIMO), an array antenna, analog beam-forming, and/or a large scale antenna. Furthermore, with the advancement of next-generation communication technologies, a wireless communication module capable of performing signal processing tasks such as channel estimation, equalization, and de-mapping may be supported by utilizing newly proposed new types of AL/ML models. As such, service optimization and data, channel estimation, or the like may be applied through an efficient network air interface. As an example, in an embodiment of the present disclosure, when the communication device 110 supports wireless access for vehicle environment (WAVE) communication, the communication device 110 may support IEEE 802.11a wireless LAN technology for smooth communication of vehicle-to-vehicle (V2V) and vehicle-to-infrastructure (V2I). Accordingly, a channel bandwidth of 10 MHz may be used in a band of 5.9 GHz, the data rate of up to 27 Mbps may be supported; CSMA/CA may be supported in a wireless channel access method, a physical layer may be based on IEEE 802.11p, and an upper layer may use the IEEE 1609.x standard.

Moreover, when the 3GPP system is supported, the communication device 110 according to an embodiment of the present disclosure may support LTE eV2X, 5G/5G-Adv, and 6G NR V2X communication technologies based on LTE V2X (Rel. 14). In general, the V2X communication includes vehicle-to-vehicle (V2V) indicating LTE/NR-based communication between vehicles, vehicle-to-pedestrian (V2P) indicating LTE/NR-based communication between vehicles and terminals carried by individuals, and vehicle-to-infrastructure/network (V2I/N) indicating LTE/NR-based communication between vehicles and roadside units/networks. Accordingly, network scalability may be improved in V2I communication by using OFDMA wireless access. Furthermore, 5G NR, 5G-Adv, 6G, and next-generation communication systems may support enhanced V2X services such as sharing sensor data of autonomous vehicles for ultra-low latency and high-reliability communication and updating high-precision map, and may consider coexistence and interoperability with existing LTE V2X. Accordingly, a safe and efficient transportation system may be supported by improving the reliability, delay time, and throughput of vehicle communication. Also, there is no limitation on the multiple access technique of a wireless communication system to which embodiments of the present disclosure may be applied. For example, various multiple access techniques such as code division multiple access (CDMA), time division multiple access (TDMA), frequency division multiple access (FDMA), orthogonal frequency division multiple access (OFDMA), single carrier-FDMA (SC-FDMA), OFDM-FDMA, OFDM-TDMA, and/or OFDM-CDMA may be used. Moreover, uplink and downlink transmissions may use either a time division duplex (TDD) method of sending data by using different times, or a frequency division duplex (FDD) method of sending data by using different frequencies.

The storage 120 may download and store various service data for the corresponding vehicle received from the server 20 through the communication device 110, and data for vehicle wireless updates. Accordingly, the storage 120 may identify and store/manage/update pieces of information about a road environment and road surrounding information such as location information of a host vehicle, road information, bus station information, etc. that are collected through vehicle sensors provided in a vehicle and the server 20. Moreover, the storage 120 may receive and store destination information set by a user, existing found routes, and infrastructure information related to outside and traffic, that may be updated in real time, depending on a predetermined cycle or predetermined service. Furthermore, according to an embodiment of the present disclosure, data for various input sensors for supporting autonomous driving, and data obtained through a server that supports road information and communication information may be stored/managed. Road information and traffic information, that are obtained by receiving pieces of communication system information through a communication server, and pieces of data input through various sensors installed inside/outside the vehicle may be stored/managed/updated.

The storage 120 may include at least one type of a storage medium among a flash memory type of a memory, a hard disk type of a memory, a micro type of a memory, or a card type (e.g., a Secure Digital (SD) card or an eXtream Digital (XD) card) of a memory, a random access memory (RAM) type of a memory, a static RAM (SRAM) type of a memory, a read-only memory (ROM) type of a memory, a programmable ROM (PROM) type of a memory, an electrically erasable PROM (EEPROM) type of a memory, a magnetic RAM (MRAM) type of a memory, a magnetic disk type of a memory, or an optical disc type of a memory.

The display device 130 may be controlled by the processor 140 to display a screen for receiving the approval of user authentication for the wireless update of a vehicle. The display device 130 may be implemented with a head-up display (HUD), a cluster, or an audio video navigation (AVN). Furthermore, the display device 130 may include at least one of a Liquid Crystal Display (LCD), a Thin Film Transistor-LCD (TFT LCD), a Light Emitting Diode (LED) display, an Organic LED (OLED) display, an Active Matrix OLED (AMOLED) display, a flexible display, a bended display, or a 3D display. Some of the displays may be implemented with a transparent display that is transparent or translucent to view the outside. Moreover, the display device 130 may be provided as a touchscreen including a touch panel and may be used as an input device in addition to an output device.

The processor 140 may be electrically connected to the communication device 110, the storage 120, the display device 130, the alarm device 150, and the like, and may electrically control each of the components. The processor 140 may be an electrical circuit that executes the instructions of the software, and may perform various data processing and calculation described below. The processor 140 may support adaptive data processing and calculation by applying a newly proposed new type of AL/ML model or considering an internally implemented AL/ML model.

When a screen for receiving approval from a user is displayed on the display device 130, the alarm device 150 may output a notification for approval to the user. In an embodiment, the alarm device 150 may provide various pieces of information for V2X services such as driving guidance, traffic safety, or the like such as resetting the route for the degree of congestion, the alarm of the degree of congestion, or the like as well as infotainment information within a vehicle.

The vehicle according to an embodiment of the present disclosure may be equipped with a plurality of electronic control apparatuses (ECUs) that are connected to internal/external communication, thereby increasing user safety and providing various convenient functions. The ECU may be a module that performs various electronic control functions within the vehicle, and may include, for example, an engine control module (ECM) that is responsible for optimizing and controlling engine performance, a transmission control module (TCM) that is responsible for managing the transmission, a brake module (BCM) that manages and controls a brake system, an airbag control unit (ACU) that controls the operation and management of an airbag, and a body control module (BCM) that manages and controls body-related functions such as door locks and interior lighting of the vehicle.

In an embodiment, a controller area network (CAN) data bus may support communication between ECUs in the vehicle. In this way, the ECUs may exchange sensor data and commands in real time with each other and may comprehensively control various functions of the vehicle. Moreover, FlexRay may be applied as a communication protocol for vehicles. The FlexRay may support data transmission rates of up to 10 Mbps and may implement redundancy or increase data transfer amount through two independent communication channels. Moreover, the FlexRay may apply a time slot concept such that all nodes on a network are capable of transmitting data without collision by using a TDMA method, and may support ADAS and autonomous driving by sharing data necessary to determine autonomous driving between ECUs. For example, data generated inside a vehicle through the FlexRay may be transmitted to other vehicles or infrastructure through a 3GPP-based communication network.

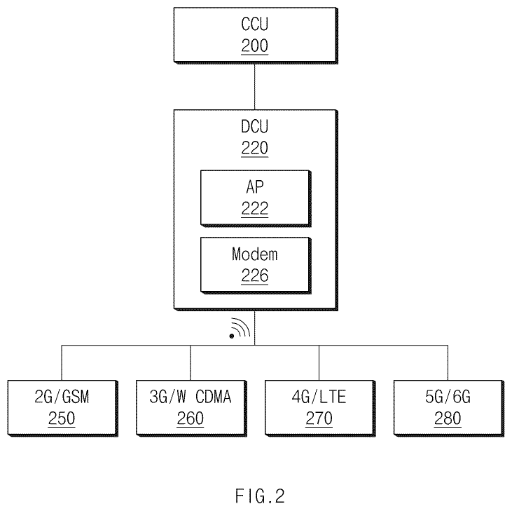

FIG. 2 is a schematic diagram of a vehicle communication control system that efficiently controls wireless network connections to reduce power consumption, according to an embodiment of the present disclosure.

Referring to FIG. 2, a communication control module (CCU) 200 may be a communication control device of a vehicle and may include a central control apparatus that manages data communication between the vehicle's internal and external networks. Moreover, The CCU 200 may provide connections between various ECUs and systems within the vehicle, as well as connections with external servers or cloud services. The CCU 200 according to an embodiment of the present disclosure may support V2X communication (e.g., data exchange between vehicles (V2V), between vehicles and infrastructure (V2I)), connected services (e.g., real-time navigation, remote diagnosis, over-the-air (OTA) update support), data gateway (e.g., a bridge role between protocols such as CAN or LIN inside a vehicle and LTE, 5G/5G-Adv, and 6G communication outside the vehicle), and security management (e.g., data encryption and intrusion detection in a vehicle communication channel).

A domain control unit (DCU) 220 may be a control device that controls and manages a specific domain (functional area) of a vehicle, and may efficiently control each domain (e.g., powertrain, body, infotainment, or the like) by integrating a plurality of distributed ECUs. For example, when ECU integration is supported, the system complexity is reduced by integrating roles of a plurality of ECUs, thereby reducing system operating costs. Furthermore, when real-time data is processed, fast and accurate data processing may be supported, which may enhance autonomous driving and vehicle control functions. When a modular design method is applied, independent management for each domain becomes possible, thereby making maintenance easier. Also, high-performance computation and optimization may be supported through smart control in the main domain (e.g., a framework or an electrical system) of a vehicle. For example, the DCU 220 may manage the vehicle's electric drive system to maximize battery efficiency, or to manage an infotainment system, thereby improving user experience.

The CCU 200, according to an embodiment of the present disclosure, may transmit and receive data through communication with the outside in an ignition (IGN) On state (e.g., a state where a vehicle's electrical system is activated, such as a state where an engine is ready to operate, a state where power is supplied to an electronic device, or a state where an ignition switch is turned on). The DCU 220 may perform main control on a vehicle domain in the IGN On state. On the other hand, in the IGN Off state (e.g., a state where all of an electrical system and an engine of a vehicle are deactivated, such as a state where the engine is turned off, and a state where an ignition switch is turned off), the CCU 200 and the DCU 220 may enter a low power mode to minimize battery usage and may operate only for basic maintenance functions. In an embodiment of the present disclosure, the CCU 200 and the DCU 220 are described as a separate unit, but the CCU 200 and the DCU 220 may be integrated within a vehicle and may operate in the IGN state, thereby maximizing the efficiency and performance of the vehicle.

According to an embodiment of the present disclosure, when the vehicle completes parking and IGN is turned off, the vehicle enters a sleep mode. This may correspond to a sleep mode of an application (AP) area 222 of the DCU 220, and may allow a modem area 226 to operate in an on state. In an embodiment, a modem-on state indicates that the corresponding vehicle is normally registered in a network, and includes a state where a connection is maintained to a next-generation communication wireless network system depending on surrounding network environments, by including a GSM 250, a WCDMA 260, an LTE 270, and an NR/5G-Adv/6G 280. This means that the modem may continuously use SMS/Call/Data and user CCS service, or vehicle-specific services of a cloud server. Accordingly, when a mobile termination (MT) short message service (SMS) arrives, the DCU modem 226 may identify the corresponding message. When the message is a valid message, the DCU modem 226 may transition the CCU 200 to be in a wake up state, and may allow the CCU 200 to use connected car service (CCS). Moreover, when the corresponding CCS service is terminated, the CCU 200 may enter a sleep state, and the DCU modem 226 may be controlled to remain in an on state while low power is maintained.

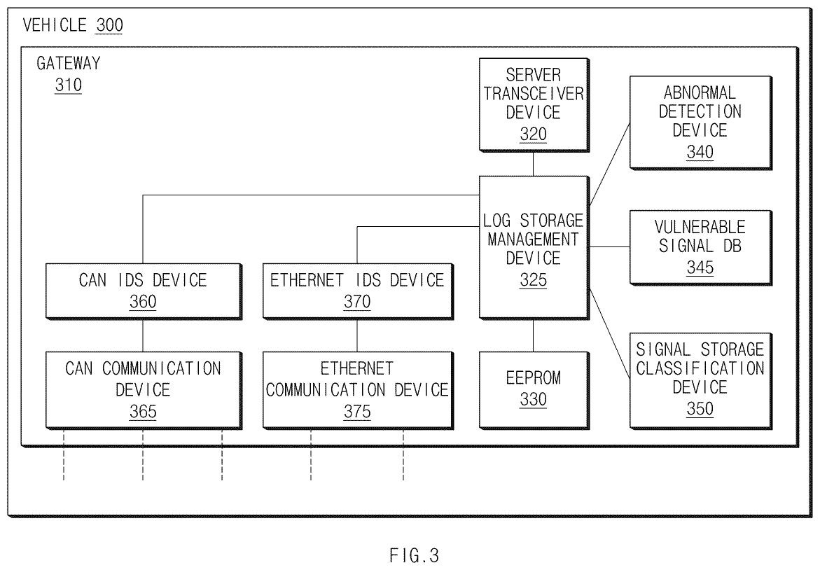

As vehicles become digital and connected, cyber security threats are also increasing. Accordingly, the vehicle control apparatus according to an embodiment of the present disclosure may support further strengthening of the protection function of the vehicle's internal network and system by integrating an intrusion detection system (IDS). Accordingly, the CCU 200 may collect and monitor data related to security through communication with the outside in the IGN On state, and may transmit and receive the detected information. The DCU 220 may control each major operation for the vehicle domain based on the collected information. According to an embodiment of the present disclosure, an operation for efficiently controlling collected logs may be performed. An operation for efficiently controlling collected logs, according to an embodiment, is described in more detail below with reference to FIG. 3.

FIG. 3 is a block diagram showing a configuration of a vehicle control apparatus including an intrusion detection system (IDS), according to an embodiment of the present disclosure.

Referring to FIG. 3, a vehicle 300 is equipped with a vehicle control apparatus capable of supporting network traffic monitoring, intrusion detection, response/blocking, logging, and reporting. The vehicle control apparatus including an intrusion detection system (IDS) according to an embodiment of the present disclosure may include a gateway 310, a server transceiver device 320, a log storage management device 325, and a memory 330. The memory 330 may include a non-volatile memory (electrically erasable programmable read-only memory (EEPROM)) that may electrically erase and rewrite data generated within a vehicle. The EEPROM refers to a memory with the limited number of writable cycles (write endurance) due to the technical characteristics thereof.

When the log storage management device 325 detects an abnormal message in the vehicle, the log storage management device 325 may record the abnormal message as a log, may read original data from the EEPROM 330 as needed to copy the original data, and may upload the data regarding the corresponding abnormal message to a central server through the server transceiver device 320. In an example, the server transceiver device 320 may be implemented through the communication control module (the CCU 200). In an embodiment, the priority of detecting abnormal messages and transmitting messages of each ECU in the vehicle domain may be set. Security-related abnormal messages may be controlled to be processed and transmitted before other data. For example, the log storage management device 325 may manage detecting and identifying abnormal messages that occur in relation to the security of a vehicle internal network and a system by identifying a CAN IDS device 360/a CAN communication device 365 and an Ethernet IDS device 370/an Ethernet communication device 375. In this way, the log storage management device 325 may control and manage the vehicle's internal system, network status, and security status. For example, it is described that a connection with external devices or servers is performed based on Ethernet-based communication, and internal vehicle communication is performed based on CAN communication. This may include application of wired/wireless networks of a new basis for integration and real-time content sharing between internal vehicle devices. In an embodiment, the log storage management device 325 may be controlled and managed through an abnormal detection device 340, a vulnerable signal database 345, and a signal storage classification device 350.

For example, when an abnormal message occurs in a vehicle, all of the corresponding messages are stored in the EEPROM for later analysis, but the write endurance of the EEPROM may be limited. Each cell of an EEPROM is exposed to electrical stimulation as write or erase operations are repeated, and the endurance of a cell is reduced as a result of repeated write/erase operations. Accordingly, when the number of repeated write/erase operations exceeds a specific count, the cell is likely to experience stability issues. This may mean that data fails to be maintained or stored, resulting in a data leak. As another example, assuming, for example, that the vehicle is in operation for 10 years or more, the stability of data of the EEPROM as well as the reliability of normal mutual control operations between vehicle control apparatuses may gradually decrease. Further, when a communication module of a vehicle or an embedded device continuously transmits an abnormal message to a server whenever the abnormal message occurs, this may also be undesirable from a cost perspective.

Accordingly, when the abnormal message is detected, the log storage management device 325 according to an embodiment of the present disclosure may distinguish between a message to be stored immediately and a message to be stored later, based on an IGN state of the vehicle, and may operate to store and manage the message accordingly, by controlling the abnormal detection device 340, the vulnerable signal database 345, and the signal storage classification device 350.

According to an embodiment of the present disclosure, even when a signal to be stored immediately occurs repeatedly in the form of an abnormal message, the log storage management device 325 may control the execution of adaptive log control and storage by applying a different error counter based on the feature of the corresponding signal. Moreover, the signal to be stored immediately based on the feature of the signal may be controlled to be transmitted to a server immediately upon detecting the signal, and the signal to be stored later based on the IGN state may be controlled to be transmitted to the server immediately before the ignition is terminated. Accordingly, efficient utilization and management of the cell endurance of the EEPROM are supported. Furthermore, the cost and transmission efficiency of server transmission of an abnormal message may be optimized. Also, the efficiency of the IDS system may be maximized by ensuring the reliability identified for each signal detected for abnormal or malicious activities in vehicle internal and external networks or an external system.

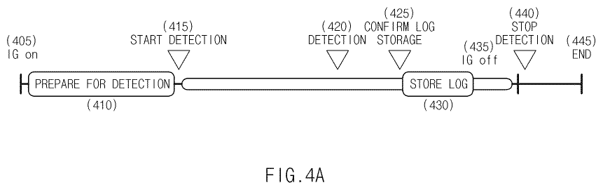

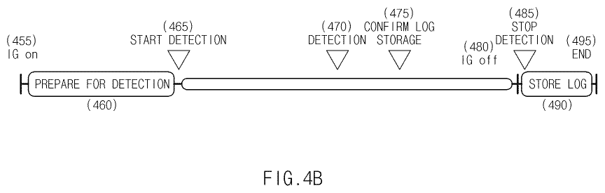

FIGS. 4A and B are conceptual diagrams for describing a method for identifying and processing abnormal messages in a vehicle control apparatus, according to an embodiment of the present disclosure. A vehicle control apparatus according to an embodiment of the present disclosure is described as supporting an intrusion detection system (IDS) by way of example.

Referring to FIG. 4A, in an operation 405, a vehicle control apparatus identifies a state of an IGN On. The state of the IGN On is a state where an engine is ready to operate. An IGN On state is a state where power is supplied to various ECUs within a vehicle and data can be transmitted and received through communication with the outside. In the IGN On state, the vehicle control apparatus may control a vehicle domain for various electronic controls within the vehicle.

In an embodiment, in the IGN On state, the vehicle control apparatus may perform an operation 410 of monitoring and preparing for detection of communication protocols such as CAN, LIN, and/or FlexRay in the vehicle in real time for security and intrusion detection between an internal network of the vehicle and an external system. The intrusion detection system (IDS) according to an embodiment of the present disclosure includes a processor that detects abnormal or malicious activities in a network or system and alerts a user such that the user is capable of perceiving the abnormal or malicious activities. For example, processes of data collection (e.g., monitoring network/system activities)/data preprocessing (e.g., converting data into an analyzable form)/log storage and reporting (e.g., keeping records and creating reports), and training and update (e.g., update for improving detection performance) may be included. As another example, applying detection methods (e.g., signature-based/behavior-based detection), determining intrusions, and providing alerts (e.g., generating alerts for abnormal activities), and executing response actions (e.g., user/administrator actions or automated blocking) may be included depending on situations.

After starting detection in an operation 415, the vehicle control apparatus monitors network/system activities and collects data related to security within the vehicle. This includes a process of determining and detecting whether there is an abnormal or unauthorized command inside the vehicle or there is a data packet. In this case, when it is identified in an operation 420 that intrusion detection is present (e.g., when the misuse of a specific CAN message is identified, or an abnormal pattern of traffic is detected through comparison with normal network traffic), it is determined, in an operation 425, whether to store the corresponding abnormal message as log data. The identified log is immediately stored in a memory (e.g., an EEPROM) in an operation 430.

According to an embodiment of the present disclosure, the abnormal message to be stored as a log immediately after detection may be a type 1 abnormal message. A type 1 abnormal message may include a message that may pose an immediate threat to the security and stability of a system inside the vehicle. For example, the type 1 abnormal message may include a message related to a system access attempt and authentication failure, a message that attempts an abnormal transition to a user's permission or an administrator's permission, a message related to malicious codes, and/or a message that includes threat possibility or security stability by modifying or deleting important files related to the system of the vehicle. Accordingly, in the operation 430, the Type 1 abnormal message determined as a threat to the security of the system inside the vehicle is immediately recorded as a real-time log upon detection.

Afterwards, when the vehicle control apparatus detects a state of the IGN Off in an operation 435 (e.g., when an engine is turned off), the vehicle control apparatus may allow at least one ECU in the vehicle to cut off power and may allow the vehicle to enter a low power mode. Accordingly, the vehicle control apparatus allows monitoring and detecting abnormal messages related to security according to IDS to be stopped in an operation 440. The vehicle control apparatus may then terminate the system within the vehicle in an operation 445.

According to an embodiment of the present disclosure, with regard to the identified type 1 abnormal message, the vehicle control apparatus may operate to block the corresponding command or to generate an alert for a notification to a user. Moreover, when the abnormal message is determined to be a message that causes serious danger, the vehicle's specific sub-system (e.g., a transmission or brake) may be controlled to switch to a safe mode and to perform an operation of minimizing damage inside and outside the vehicle. Furthermore, the vehicle control apparatus may operate in a mode for response and security enhancement by analyzing the stored log data for intrusion detection.

Referring to FIG. 4B, according to an embodiment of the present disclosure, a log recording and storing process for an abnormal message to be stored later is described. The corresponding abnormal message may include a type 2 abnormal message for later analysis rather than immediate threats. For example, the vehicle control apparatus identifies a state of the IGN On in an operation 455, supplies power to various ECUs in the vehicle, and waits for data transmission and reception through communication with the outside. Accordingly, in an operation 460, the vehicle control apparatus prepares for monitoring the activities of the internal network of the vehicle and the external system. After starting detection in an operation 465, when it is identified, in an operation 470, that the type 2 abnormal message occurs during a network/system activity monitoring process, the vehicle control apparatus determines whether to store the abnormal message as log data in an operation 475. For example, the type 2 abnormal message may include an abnormal message or traffic that occurs when ECU data is collected or software is debugged while a vehicle manufacturer or mechanic connects test equipment. As another example, the type 2 abnormal message may include a message transmitted over the network during a short time, with regard to an ECU update or reboot. As yet another example, the type 2 abnormal message may include a case where a vehicle owner uses third-party software (e.g., software for vehicle performance tuning) to change the operation of a specific ECU, or a case where unexpected traffic occurs while a user's mobile phone or another device connects to a vehicle system (e.g., infotainment). As still another example, the type 2 abnormal message may include a case where incorrect data is transmitted (e.g., transmitting incorrect speed data even when the vehicle is stopped while a speed sensor fails) because a sensor is physically damaged or while a sensor is replaced, or a case where an aged sensor intermittently sends abnormal values to a network. As yet another example, the type 2 abnormal message may include a case where, depending on changes in network traffic within the vehicle, more messages are generated than expected due to activation of an additional function within the vehicle, or a case where some messages are delayed while network traffic is increased or abnormal messages are generated because the vehicle has crashed.

The type 2 abnormal message may be a message that is less related to direct attacks and threats to the security of a system inside or outside the vehicle. Accordingly, type 2 abnormal message may not need to be stored as a log immediately after detection, and may be recorded and managed as log data for an operation of the system later. According to an embodiment of the present disclosure, the priority of log data that an abnormal message is stored as may vary depending on the vehicle's security policy and system environment. Additionally, or alternatively, the log data may be recorded, stored, and managed differently depending on a user's service operation and service-specific security policies. Moreover, log confirmation and log records may be stored and managed with different priorities, based on the number of occurrences of abnormal traffic patterns and temporary increases in network traffic, depending on the importance of each service. For example, the type 2 abnormal message may be selectively recorded and stored as a log for use in education or policy improvement later, such as actions that violate the user's security policy.

Afterwards, when detecting the IGN Off state in an operation 480, the vehicle control apparatus cuts off the power supply to at least one ECU in the vehicle and allows the monitoring and detection of abnormal messages according to the IDS to stop in an operation 485. The vehicle control apparatus stores abnormal messages in the confirmed type 2 as log data in an operation 490. In an operation 495, the vehicle control apparatus terminates the system within the vehicle.

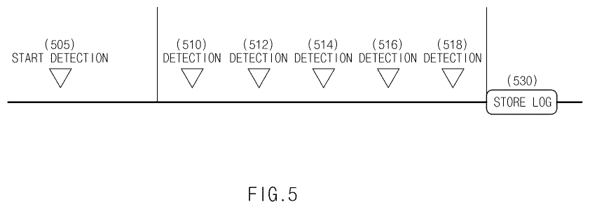

FIG. 5 is a conceptual diagram for describing a method for identifying and processing abnormal messages in a vehicle control apparatus, according to another embodiment of the present disclosure.

Referring to FIG. 5, after starting detection in an operation 505, a vehicle control apparatus identifies or determines an occurrence of abnormal messages of a specific ECU and detects intrusions through a network/system activity monitoring process in operations 510, 512, 514, 516, and 518. In an operation 530, the vehicle control apparatus controls recording and managing of logs for the abnormal messages based on the security priority for the security and stability of a system inside a vehicle set for each ECU. When an abnormal message is identified, the vehicle control apparatus counts a specific count for the detected signal based on how closely the abnormal message is related to the safety and vulnerability of the vehicle, and confirms and stores the detected messages as logs based on a set value related to security vulnerability. The vehicle control apparatus monitors the occurring abnormal message in the specific count, confirms the occurring abnormal message as a final abnormality by setting the priority for log storage for each ECU based on the vulnerability and risk of security as well as the importance of each service, and controls/manages the confirmed log data to be stored.

According to an embodiment of the present disclosure, the abnormal message for each ECU may be determined in a form as shown in Table 1. These abnormal messages are detected by an abnormal detection ruleset and may be stored and managed based on rules identified based on the safety of the vehicle. For example, according to the abnormal detection ruleset, messages that deviate from normal criteria may be stored as logs by comparing the collected abnormal messages with predefined rules as shown in Table 1.

TABLE 1

| | Error | | | Method of |
|---|---|---|---|---|
| | counter | Safety | Vulnerable | storing |
| Signal | threshold | Influence | DB Signal | violations |
| ECU#1 | 5 | ◯ | ◯ | Immediately |
| TCU#2 | 5 | ◯ | ◯ | Immediately |
| AVN#1 | 5 | X | X | IG OFF |
| IMMO | 2 | ◯ | ◯ | Immediately |
| Steering | 2 | ◯ | X | Immediately |
| Default | 5 | X | X | IG OFF |

According to an embodiment of the present disclosure, the vehicle control apparatus may distinguish between an abnormal message to be stored immediately upon detection and an abnormal message to be stored later based on the role and stability of each ECU, vulnerable signals, and the importance of log management. The vehicle control apparatus may set and manage different log storage reference values, thereby efficiently managing logs based on stability and vulnerability and supporting security policies.

For example, ECU #1 may include one of ECUs that control various functions (e.g., controlling an engine, a brake system, or the like) within the vehicle that are critical to the operation of the vehicle. While ECU #1 is sending and receiving data over CAN, FlexRay, or Ethernet networks, when an abnormal message pattern (e.g., missing of periodic messages or increasing frequency of periodic messages) occurs, an abnormal data value (e.g., a value of abnormally high engine temperature) is generated, or an ECU sends or receives unintended data to or from a destination with which the ECU should not communicate, an abnormal message may be detected. When it is identified that the error counter threshold of the detected signal related to ECU #1 is greater than 5, as this is directly related to the stability of the system (i.e., based on the safety impact and vulnerable DB signal), the identified abnormal message is immediately stored as a log in an EEPROM.

With regard to Transmission Control Unit #2 (TCU #2), TCU #2 is a device that controls the transmission according to gear settings based on vehicle speed, torque, or the like, which is also an important device for vehicle stability and security. Accordingly, with respect to TCU #2, when there is an abnormal shift request pattern, it is detected that an abnormal CAN command is transmitted, or there is a message indicating a transmission failure while firmware of TCU #2 is updated, the vehicle control apparatus counts a detection signal, compares the counted result with a predetermined error counter threshold to determine whether the counted result exceeds the predetermined error counter threshold (e.g., 5), and immediately stores the identified abnormal message as a log in the EEPROM.

Audio, Video, Navigation System #1 (AVN #1) is a device related to audio/video playback, navigation, and smartphone connection in association with an in-vehicle infotainment system, and abnormal messages related to security and system stability may occur in a process of connection with an external device. For example, when a malicious code coming in through Bluetooth, Wi-Fi, or USB is detected, abnormal traffic is transmitted to another ECU through the AVN system, or GPS signal spoofing (e.g., location information distortion) is detected, the vehicle control apparatus determines whether the error counter threshold of the detection signal is greater than 5, and stores the generated abnormal message in the EEPROM as a log that is generated before IGN Off state, because the message may be relatively less related to the risk of a vulnerable DB and direct safety impact in view of a security on the vehicle's user and internal system.

An immobilizer (IMMO) is a device related to vehicle theft prevention, and is an important device that determines whether to operate an engine based on a key or authentication data in terms of safety and security. Accordingly, with regard to the IMMO, when abnormal key authentication attempts, excessive authentication failure attempts (e.g., brute force attack detection), or a situation in which IMMO messages are intercepted or tamper (Man-in-the-Middle attack) is detected, the vehicle control apparatus counts the number of violations thereof and determines whether the counted number of violations reaches a predetermined log setting value (e.g., 2), records the generated abnormal messages as a log, and provides the log so as to respond to security. With regard to theft prevention, the abnormal message is not managed as a vulnerable DB. However, when the number of violations of the abnormal message exceeds the predetermined number of violations as the abnormal message is directly connected to the stability impact, the abnormal message may be managed to be immediately recorded as log data.

A steering control unit (Steering) is a device that controls a steering system. For example, in an electronic power steering (EPS) system, steering control is an important security element related to user stability and autonomous driving. The vehicle control apparatus identifies the integrity of a steering command, and whether a steering operation is normal. When an abnormal change in steering angle data is detected, a command change is attempted in the EPS system (e.g., an attacker enters an abnormal command into a steering system), or an abnormal period (an attack that interferes with periodic data) is detected, it is identified that the steering data is manipulated by someone (a device) and thus the vehicle may move in an unintended direction. The vehicle control apparatus counts the number of violations, determines whether the counted number of violations reaches a predetermined value (e.g., 2), and causes the occurring abnormal messages to be immediately stored as logs.

In an embodiment, a default value (Default) refers to a default setting value when a specific ECU or system is initialized or is in an abnormal state. The vehicle control apparatus identifies that an abnormal initialization message of an ECU set to the default value occurs, it is determined whether an abnormal command is received from the outside during an initialization process, or an initialized ECU unintentionally generates excessive traffic on a network. The vehicle control apparatus counts the number of violations of the corresponding abnormal message, determines whether the counted number of violations reaches a default setting value (e.g., 5), and stores the abnormal message in the EEPROM as a log that is generated before IGN Off state.

As described above, according to an embodiment of the present disclosure, an abnormal message is controlled to be stored immediately upon detection based the security characteristics of a signal closely related to the safety and vulnerability of the vehicle; the abnormal message is controlled to be stored after the specific number of times; or messages are managed by identifying the abnormal message such that the abnormal message is stored before a system operation in the vehicle is terminated. Thus, for example, based on a security characteristic of an abnormal message, the abnormal message may be controlled to be i) stored immediately upon detection, ii) stored after a specific number of times of occurrence, or iii) stored before a system operation in the vehicle is terminated. Accordingly, efficiency in the operation of memory with physical limitations and efficiency in management of occurring messages on a communication interface is provided.

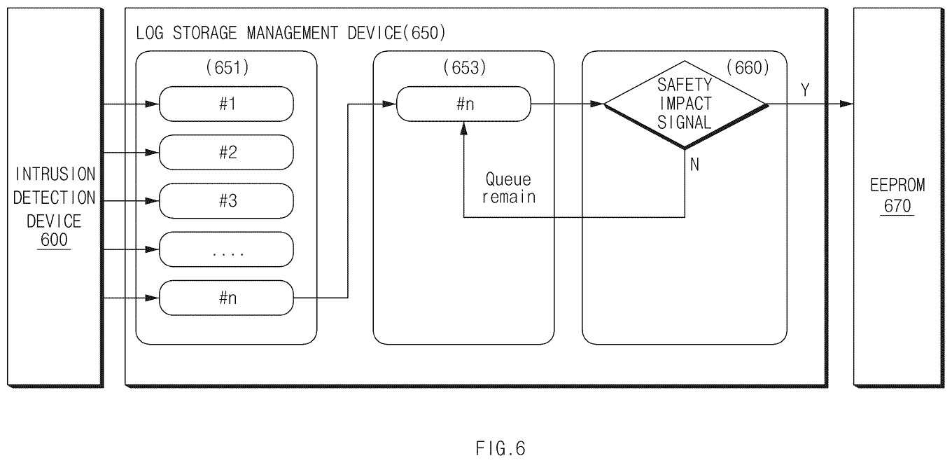

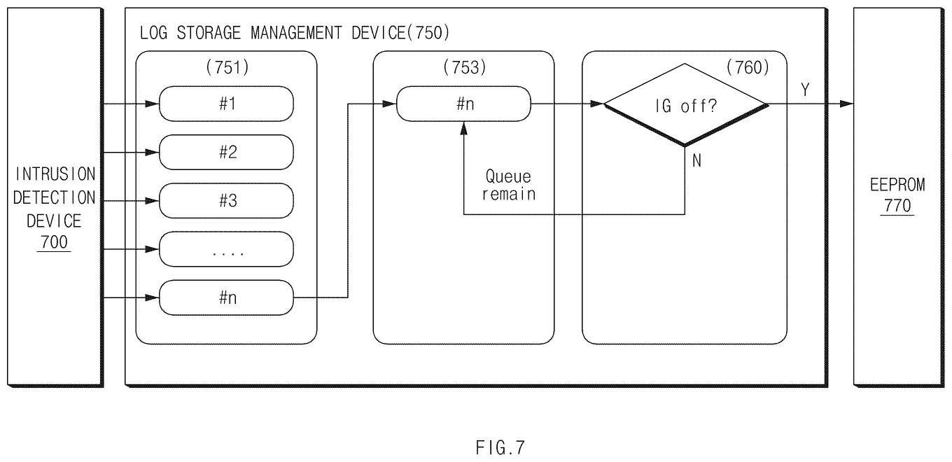

FIGS. 6 and 7 are conceptual diagrams for describing a process for identifying and processing abnormal messages in a vehicle control apparatus, according to an embodiment of the present disclosure.

Referring to FIG. 6, with respect to abnormal messages detected by an intrusion detection device 600, a log storage management device 650 may control the storage and management of an EEPROM 670 based on the role and stability of each ECU, vulnerability of the signal, and/or the importance of log management. A first message queue module 651 of the log storage management device 650 identifies the abnormal message of each ECU detected by the intrusion detection device 600 and counts the number of abnormalities. A second message queue module 653 of the log storage management device 650 compares the identified abnormal message with a different reference value set for each ECU and identifies the corresponding abnormal message as a log. In various embodiments, the at least one memory queue module 651 or 653 of the log storage management device 650 may be implemented as an independent memory queue module of a separate structure depending on the operation thereof, or one queue module may be implemented to operate as a logical module in software.

A log handler 660 identifies the confirmed log and determines whether the corresponding log is to be immediately stored in the EEPROM 670, based on the importance of safety or security vulnerability in the vehicle. When the confirmed log is determined to be a signal closely related to safety (660, Y), the log handler 660 stores the confirmed log in the EEPROM. When the confirmed log is determined to be a signal closely related to safety and it is determined that the occurrence of a specific number of times of occurrence is to be considered (660, N), the log handler 660 stores the log in EEPROM after the set specific number of times. Further, when the confirmed log is determined to be an abnormal message for later analysis within the vehicle rather than an immediate threat, as illustrated in FIG. 7, a log handler 760 stores the log data in an EEPROM 770 according to the IGN Off state of the vehicle.

As described above, the log handler 660 or 760 may identify an occurring abnormal message 651 or 751, may apply a different error counter set based on the security characteristics of the corresponding abnormal message 653 or 753, and may perform adaptive log confirmation 660 or 670 and storage in the EEPROM 670 or 770. For example, with regard to abnormal messages occurring in relation to intrusion detection, the log handler may set different log reference values by distinguishing between type 1 message (e.g., ECU #1, TCU #2, IMMO, and Steering in Table 1) to be stored immediately upon detection and type 2 message (e.g., AVN #1 and Default in Table 1) to be stored later. Moreover, the log handler may set immediate storage to the EEPROM or storage at IGN Off, based on the importance and safety of system security in the vehicle.

The EEPROM 670 stores log data received from the log storage management device 650. In an embodiment, a method of deleting the oldest data and storing new data in a First-In, First-Out (FIFO) manner may be applied to the EEPROM 670. In addition, according to an embodiment of the present disclosure, priority may be set such that important abnormal messages related to system security are not overwritten. Accordingly, storage management may be effectively supported with respect to the limited storage capacity of the EEPROM. Afterwards, data stored in the EEPROM 670 may be downloaded and analyzed by a user and/or a system administrator. Accordingly, the user or the administrator may identify the stability and reliability of the security system within the vehicle by identifying the network abnormality patterns, abnormal communication between ECUs, and potential intrusion attempt records stored in the EEPROM, thereby supporting more efficient security policies and vehicle system and network management methods.

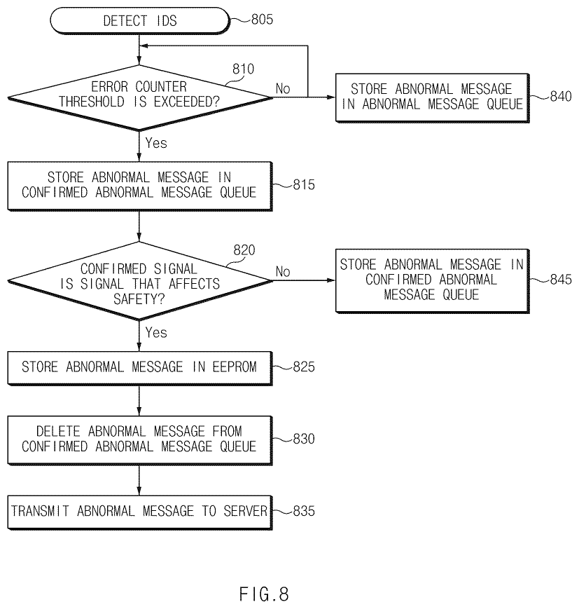

FIG. 8 is a signal flow diagram for describing a process of identifying and processing abnormal messages, according to an embodiment of the present disclosure.

Referring to FIG. 8, in an operation 805, a processor identifies the occurrence of an abnormal message and intrusion detection of a specific ECU. In an operation 810, the processor determines or identifies (e.g., counts) a number of occurrences of the abnormal message and compares the number of occurrences of the abnormal message with an error counter threshold (ECT). In an embodiment, the ECT may be set to a predetermined value. In an embodiment, the abnormal messages may be detected based on an abnormal detection ruleset and may be stored and managed according to rules identified according to the safety of the vehicle. The error counter threshold may be a different error reference value set depending on the role of the corresponding ECU, system stability, and security vulnerabilities.

Based on determining that the number of occurrences of an abnormal message reaches the error counter threshold (ECT), the processor stores the corresponding abnormal message in a second message queue in an operation 815. In an embodiment, the second message queue is a confirmed abnormal message queue configured to store abnormal messages confirmed as abnormal messages to be logged. On the other hand, based on determining that the number of occurrences of the abnormal message does not reach the predetermined error counter threshold (ECT), the processor stores the abnormal message in a first message queue in an operation 840. In an embodiment, the first message queue is an abnormal message queue configured to store abnormal messages not confirmed (or not yet confirmed) as abnormal messages to be logged.

In an operation 820, the processor determines whether the abnormal message stored in the confirmed abnormal message queue is a signal that affects the safety of the vehicle. When the confirmed abnormal message is determined to be a signal closely related to safety (Yes in the operation 820), the processor immediately stores the abnormal message as a log in an EEPROM in an operation 825. In an operation 830, the abnormal message stored in the confirmed abnormal message queue is deleted according to the FIFO method. In an operation 835, the processor transmits the abnormal message stored in the EEPROM to a server. Accordingly, the processor transmits the abnormal message stored in the EEPROM to the server, connects a vehicle IDS and an external server, and enables a cloud or a central system to analyze and manage abnormal data detected in a vehicle network. To this end, network communication protocols and security technologies may be used. The server may store and analyze the received data used to detect abnormal signs or to strengthen security measures. Furthermore, the processor may provide alerts to users and administrators through the system. For example, real-time feedback (e.g. blocking a specific ECU) may be provided to the vehicle network. On the other hand, when the confirmed abnormal message is determined to be an abnormal message for later analysis rather than an immediate threat (No in the operation 825), the processor keeps and manages the confirmed abnormal message in the confirmed abnormal message queue in an operation 845.

In an embodiment, the abnormal detection ruleset may be strengthened by simulating potential abnormal activities through the confirmed abnormal message queue. Furthermore, the processor may control the abnormal detection ruleset through the intrusion detection system by transmitting the abnormal message to the server through log data, thereby effectively controlling the stability and safety of the intrusion detection system.

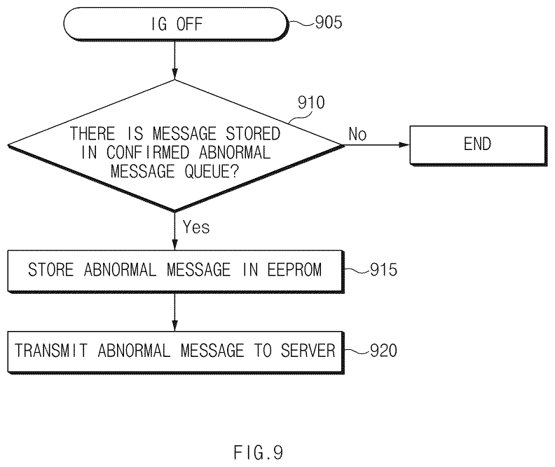

FIG. 9 is a signal flow diagram for describing a process of identifying and processing an abnormal message, according to an embodiment of the present disclosure.

Referring to FIG. 9, in identifying occurrence of abnormal messages of a specific ECU and intrusion detection, comparing the number of occurrences of the identified abnormal message with (e.g., a predetermined) error counter threshold, and storing the abnormal messages in an EEPROM, a processor may consider the IGN Off state of the vehicle. In an operation 905, the processor identifies an IGN Off state. In an operation 910, the processor determines whether an abnormal message is stored in a confirmed abnormal message queue. In an operation 915, the abnormal message stored in the confirmed abnormal message queue is stored as logs in the EEPROM based on identifying the IGN Off state. Additionally, or alternatively, in an embodiment, the abnormal message stored the abnormal message queue is stored in the EEPROM based on identifying the IGN Off state. In an operation 920, the abnormal message stored in the EEPROM is transmitted to a server.

The processor transmits log data corresponding to the abnormal message to the server based on identifying the IGN Off state, thereby maximizing the transmission efficiency of the message through a communication module and supporting cost efficiency for log transmission.

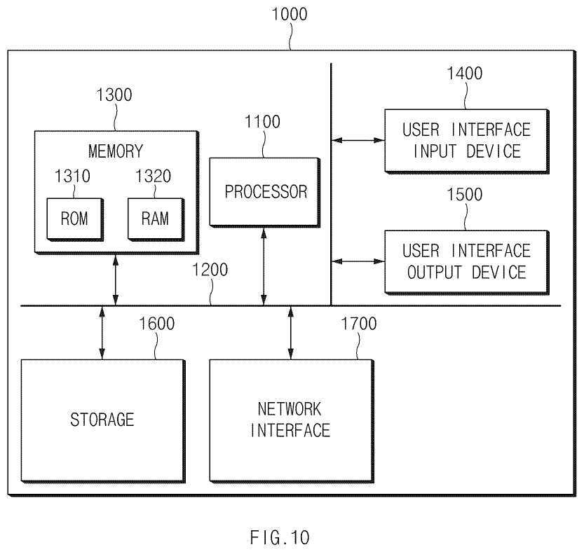

FIG. 10 illustrates a computing system according to an embodiment of the present disclosure.

Referring to FIG. 10, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (PAM).

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The above description is merely an example of the technical idea of the present disclosure, and various modifications and modifications may be made by one of ordinary skill in the art without departing from the essential characteristic of the present disclosure.

Accordingly, described embodiments of the present disclosure are intended not to limit but to explain the technical idea of the present disclosure, and the scope and spirit of the present disclosure is not limited by the described embodiments. The scope of protection of the present disclosure should be construed by the attached claims, and all equivalents thereof should be construed as being included within the scope of the present disclosure.

Embodiments of the present disclosure support an efficient intrusion detection system that sets different violation reference values according to the characteristics of the corresponding abnormal message based on the role of a system in a vehicle, the safety for security, and vulnerability scenarios.

In this way, essential security and maintenance strategies may be supported in connected cars and autonomous vehicle environments.

Moreover, embodiments of the present disclosure may consider the external security and stability of a vehicle system, and may support the operation of limited memory, efficient security policies, and a method of managing the vehicle system and a network by storing confirmed log data in EEPROM according to priorities.

Further, a variety of effects directly or indirectly understood through the present disclosure may be provided.

Hereinabove, although the present disclosure was described with reference to example embodiments and the accompanying drawings, the present disclosure is not limited thereto, but may be variously modified and altered by those having ordinary skill in the art to which the present disclosure pertains without departing from the spirit and scope of the present disclosure claimed in the following claims.

What is claimed is:

1. A vehicle control apparatus comprising:
a storage including a first message queue and a second message queue for storing messages in a vehicle; and
a processor configured to
detect an abnormal message,
determine a number of occurrences of the abnormal message,
compare the number of occurrences of the abnormal message with an error counter threshold,
store the abnormal message in the first message queue or the second message queue based on the comparison,
store the abnormal message stored in the second message queue as log data in a memory based on determining whether the abnormal message is a signal affecting safety in the vehicle, and
transmit the log data stored in the memory to a server.

2. The vehicle control apparatus of claim 1, wherein the processor is configured to variably set the error counter threshold based on an electronic control unit (ECU) associated with the abnormal message.

3. The vehicle control apparatus of claim 1, wherein the processor is configured to compare the number of occurrences of the abnormal message with the error counter threshold by applying an abnormal detection ruleset.

4. The vehicle control apparatus of claim 3, wherein the processor is configured to apply the abnormal detection ruleset that variably sets the error counter threshold based on at least one of a role and stability of an ECU associated with the abnormal message, a signal vulnerability, or importance of log management.

5. The vehicle control apparatus of claim 4, wherein the processor is configured to store the abnormal message in the second message queue based on determining that the number of occurrences of the abnormal message reaches the error counter threshold, wherein the second message queue is a confirmed abnormal message queue.

6. The vehicle control apparatus of claim 5, wherein the processor is configured to store the abnormal message stored in the second message queue as the log data in the memory based on determining that the abnormal message stored in the second message queue is a signal that affects safety of the vehicle.

7. The vehicle control apparatus of claim 6, wherein the memory comprises a an electrically erasable programmable read-only memory (EEPROM).

8. The vehicle control apparatus of claim 4, wherein the processor is configured to store the abnormal message in the first message queue based on determining that the number of occurrences of the abnormal message does not reach the error counter threshold, and wherein the first message queue is an abnormal message queue.

9. The vehicle control apparatus of claim 8, wherein the processor is configured to store the abnormal message stored in the first message queue as log data in the memory based on determining that an engine of the vehicle is in a deactivated state (IGN Off).

10. The vehicle control apparatus of claim 1, wherein the processor is configured to transmit the abnormal message stored in the memory to the server as the log data to allow the server to update an abnormal detection ruleset for an intrusion detection system that detects the abnormal message.

11. A vehicle control method, the method comprising:
detecting an abnormal message;
determining a number of occurrences of the detected abnormal message;
comparing the number of occurrences of the abnormal message with an error counter threshold;
storing the abnormal message in a first message queue or a second message queue depending to the comparison;
storing the abnormal message as log data in a memory based on determining whether the abnormal message is a signal affecting safety in a vehicle; and
transmitting the log data stored in the memory to a server.

12. The vehicle control method of claim 11, further comprising variably setting the error counter threshold based on an electronic control unit (ECU) associated with the abnormal message.

13. The vehicle control method of claim 11, wherein comparing the number of occurrences of the abnormal message with the error counter threshold includes comparing the number of occurrences of the abnormal message with the error counter threshold by applying an abnormal detection ruleset.

14. The vehicle control method of claim 13, wherein applying the abnormal detection ruleset includes variably setting the error counter threshold based on at least one of a role and stability of an electronic control unit (ECU) associated with the abnormal message, a signal vulnerability, or importance of log management.

15. The vehicle control method of claim 14, wherein storing the abnormal message in the second message queue includes storing the abnormal message in the second message queue based on determining that the number of occurrences of the abnormal message reaches the error counter threshold, wherein the second message queue further is a confirmed abnormal message queue.

16. The vehicle control method of claim 15, wherein storing the abnormal message stored in the second message queue as the log data in the memory includes storing the abnormal message stored in the second message queue as the log data in the memory based on determining that the abnormal message stored in the second message queue is a signal that affects safety of the vehicle.

17. The vehicle control method of claim 16, wherein the memory comprises a electrically erasable programmable read-only memory (EEPROM).

18. The vehicle control method of claim 14, wherein storing the abnormal message in the first message queue including storing the abnormal message in the first message queue based on determining that the number of occurrences of the abnormal message does not reach the error counter threshold, wherein the first message queue further is an abnormal message queue.

19. The vehicle control method of claim 18, further comprising storing the abnormal message stored in the first message queue as the log data in the memory based on determining that an engine of the vehicle being is in a deactivated state (IGN Off).

20. The vehicle control method of claim 11, further comprising updating an abnormal detection ruleset for an intrusion detection system that detects the abnormal message, wherein the abnormal detection ruleset is updated based on the log data transmitted to the server.
